(19) United States
(12) Patent Application Publication
(10) Pub. No.: US 2023/0320391 A1
(43) Pub. Date: Oct. 12, 2023

(54) SCORCHED RICE SNACK AND METHOD OF PRODUCING THE SAME

(71) Applicant: Yu Jin PARK, Gyeonggi-do (KR)

(72) Inventor: Yu Jin PARK, Gyeonggi-do (KR)

(21) Appl. No.: 17/715,280

(22) Filed: Apr. 7, 2022

(51) Int. Cl. A23L 7/126; A23L 33/125; A23L 7/10

(52) U.S. Cl. CPC A23L 7/126; A23L 33/125; A23L 7/1975

(57) ABSTRACT

Provided is a scorched rice snack including: a scorched rice base composed of brown rice; and a mixture including sugar cooled after mixing and heating 5 to 10 g weight of sodium bicarbonate and 0.25 to 0.5 g weight of corn starch, based on 100 g weight of liquefied sugar with respect to the liquefied sugar containing glucose and fructose, wherein the cooled mixture is cut into chips in a planarized state, arranged at regular intervals on the scorched rise base, further heated, and then cooled.

### BACKGROUND

The present invention relates to a scorched rice snack and, more particularly, to a scorched rice snack and a method of producing the same, capable of providing the convenience of use and the beauty of a snack by enabling a user to complexly feel the sweetness of the complex carbohydrate with respect to the scorched rice and the sweetness of the amorphous sugar.

The scorched rice is generally a byproduct generated upon cooking rice in a pot, and is known to be formed by sticking a portion of the rice to the bottom of the pot.

Conventionally, the scorched rice has been used as a beverage using the scorched rice boiled with water, but recently, users using the scorched rice as a general snack have been increasing.

As a result, the conventional techniques of the method of producing the scorched rice are disclosed in Patent Registration Publication Nos. KR 10-0529823, KR 10-0475598, and KR 10-0202266, and Patent Publication Nos. KR 10-2013-0129586 and KR 10-2006-0083074, but all of the above conventional techniques use rice as a main ingredient; it is limited to the provision of a taste, because a carbohydrate, which is a main component of rice, is provided as a main component of a snack.

However, in recent years, the demand of general consumers for snacks that may have various tastes, in particular snacks using scorched rice has been expanding.

Therefore, there is a need for the development of scorched rice snacks and manufacturing methods thereof that can meet the needs of these general consumers.

### SUMMARY OF THE INVENTION

Accordingly, it is an object of the present invention to provide a scorched rice snack capable of enabling the flavor of the saccharides converted by carbohydrates which are a main ingredient of rice and the flavor of saccharides consisting of fructose to be individually or complexly felt in the same snack.

In addition, it is another object of the present invention to provide a scorched rice snack capable of providing a stabilized shape and a flavor in a process in which a saccharide consisting of fructose is added to scorched rice made of carbohydrate.

According to one aspect of the present invention, there is provided a scorched rice snack comprising: a scorched rice base composed of brown rice; and a mixture including sugar cooled after mixing and heating 5 to 10 g weight of sodium bicarbonate and 0.25 to 0.5 g weight of corn starch, based on 100 g weight of liquefied sugar with respect to the liquefied sugar containing glucose and fructose, wherein the cooled mixture is cut into chips in a planarized state, arranged at regular intervals on the scorched rise base, further heated, and then cooled.

Preferably, the liquefied sugar further comprises 4 to 9 mg content of calcium, 1 to 2 mg content of magnesium, and 1 to 147 mg content of potassium based on 100 g content of the liquefied sugar.

Meanwhile, according to another aspect of the present invention, there is provided a method of producing a scorched rice snack, the method comprising: a first step of primarily heating the brown rice immersed in cold water at a temperature of 100° C. or higher and then planarizing the brown rice with a thickness of 10 to 20 mm using a planarization member with respect to the cooked brown rice; a second step of secondarily heating and drying the planarized brown rice at a temperature of about 200° C. for 4 to 6 minutes to thereby primarily form a scorched rice base including brown rice; a third step of heating and liquefying sugar containing glucose and fructose; a fourth step of forming a mixture including sugar by mixing and heating to 10 g weight of sodium bicarbonate and 0.25 to 0.5 g weight of corn starch, based on 100 g weight of liquefied sugar with respect to the liquefied sugar; a fifth step of cooling the mixture to a temperature of 18° C. while the mixture is evenly compressed to a thickness of 3 to 5 mm through a compression member; a sixth step of cutting the cooled mixture into a plurality of chips while maintaining a planarized state with respect to the cooled mixture; and a seventh step of heating and cooling the chips of the cut mixture in a state in which the chips of the cut mixture are arranged to have a predetermined interval on the surface of the primarily formed scorched rice base made of brown rice.

Therefore, a user using a scorched rice snack according to a preferred embodiment of the present invention may not only use the scorched rice snack without inconvenience due to sugar stickiness, but also the sugar component of the brown rice made of carbohydrates and the sugar component containing fructose provide sweet taste, differently from taste of the brown rice area thereby further improving the preference.

### BRIEF DESCRIPTION OF THE DRAWINGS

FIG. 1 is a flowchart illustrating a process of manufacturing a scorched rice snack according to a preferred embodiment of the present invention.

### DETAILED DESCRIPTION OF THE INVENTION

Hereinafter, with reference to the accompanying drawings, it will be described in detail with respect to a scorched rice snack according to a preferred embodiment of the present invention.

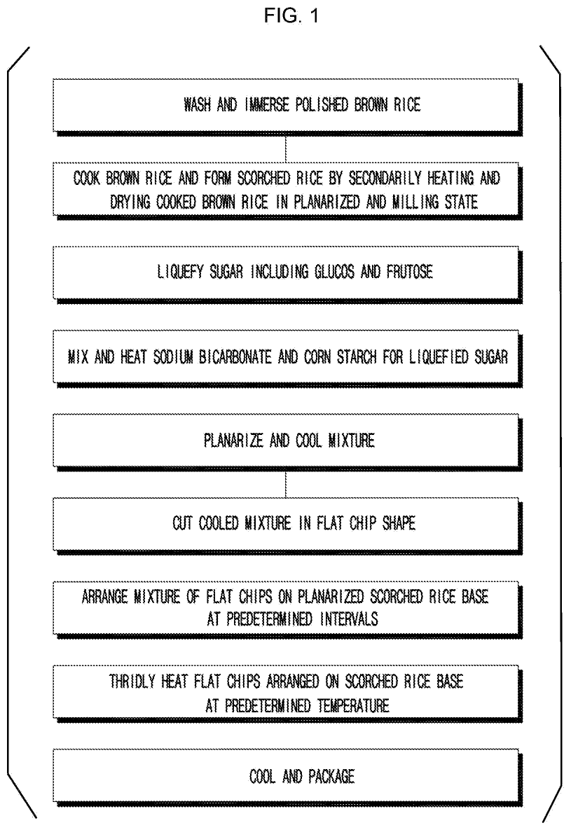

FIG. 1 is a flowchart illustrating a process of manufacturing a scorched rice snack according to a preferred embodiment of the present invention.

As shown in FIG. 1, according to the scorched rice snack according to the preferred embodiment of the present invention, the polished brown rice is washed within 24 hours, and then immersed for 3 hours at a temperature of 18° C. or lower.

Thereafter, the immersed brown rice is primarily heated and cooked to a temperature of 100° C. or more, and then the cooked brown rice is planarized to a thickness of 10 to 20 mm using a roller or the like.

The planarized brown rice is secondarily heated and dried at a temperature of about 200° C. for 4 to 6 minutes to primarily form a scorched rice base made of brown rice.

Meanwhile, sugar containing glucose and fructose is heated and liquefied to a temperature of 80 to 100° C.

In this case, it is preferable that the liquefied sugar is obtained by heating and liquefying, at a temperature of 80 to 100° C. for 1 to 2 minutes, the sugars obtained through extracting, heating and drying processes of the raw sugar of the sugar cane. Here, preferably, the liquefied sugar further includes 4 to 9 mg content of calcium, 1 to 2 mg content of magnesium, and 1 to 147 mg content of potassium based on 100 g content of the liquefied sugar.

Thereafter, a mixture including sugar is formed by mixing and heating 5 to 10 g weight of sodium bicarbonate and 0.25 to 0.5 g weight of corn starch, at a temperature of 80 to 100° C. for about 1 to 2 minutes, based on 100 g weight of liquefied sugar with respect to the liquefied sugar.

Then, the mixture is cooled to a temperature of 18° C. while the mixture is evenly compressed to a thickness of 3 to 5 mm through a compression member.

Thereafter, the cooled mixture is cut into chips to a predetermined size, preferably about 1-2 cd, while maintaining a planarized state.

Then, the chips of the cut mixture are arranged at a predetermined interval, preferably 1 to 3 cm on the surface of the scorched rice base made of the primarily formed brown rice.

The scorched rice base in which the chips are arranged is then heated in an oven at a temperature of about 100° C. to 200° C., preferably 120 to 150° C. for 2 to 3 minutes.

Thereafter, after cooling the scorched rice snack to the room temperature, the scorched rice snack is cut and packaged in a predetermined size.

As described above, according to the present invention, in the scorched rice snack made of brown rice grains, the component of the sugars, which are arranged at a predetermined interval on the upper portion of the scorched rice snack, may be induced in a partial interfacial activation state with respect to the surfaces of the brown rice grains due to the components of sodium bicarbonate and corn starch. Accordingly, the sugar component maintains proper penetration into the brown rice grains located on the surface of the scorched rice snack, and simultaneously the upper surfaces of the chips arranged at regular intervals on the surface of the scorched rice snack may maintain their shapes almost intact.

Therefore, a user using a scorched rice snack according to a preferred embodiment of the present invention may not only use the scorched rice snack without inconvenience due to sugar stickiness, but also the sugar component of the brown rice made of carbohydrates and the sugar component containing fructose provide sweet taste, differently from taste of the brown rice area thereby further improving the preference.

What is claimed is:

1. A scorched rice snack comprising:
a scorched rice base composed of brown rice; and
a mixture including sugar cooled after heating in a state in which 5 to 10 g weight ratio of sodium bicarbonate and 0.25 to 0.5 g weight ratio of corn starch are mixed with each other based on 100 g weight ratio of liquefied sugar with respect to the liquefied sugar containing glucose and fructose, wherein
the cooled mixture is cut into chips in a planarized state, arranged at regular intervals on the scorched rise base, further heated, and then cooled.

2. The scorched rice snack according to claim 1, wherein the liquefied sugar further comprises 4 to 9 mg content ratio of calcium, 1 to 2 mg content ratio of magnesium, and 1 to 147 mg content ratio of potassium with respect to 100 g content ratio of the liquefied sugar.

3. A method of producing a scorched rice snack, the method comprising:
a first step of primarily heating the brown rice immersed in cold water at a temperature of 100° C. or higher and then planarizing the brown rice with a thickness of 10 to 20 mm using a planarization member with respect to the cooked brown rice;
a second step of secondarily heating and drying the planarized brown rice at a temperature of about 200° C. for 4 to 6 minutes to thereby primarily form a scorched rice base including brown rice;
a third step of heating and liquefying sugar containing glucose and fructose;
a fourth step of forming a mixture including sugar by mixing and heating 5 to 10 g weight of sodium bicarbonate and 0.25 to 0.5 g weight of corn starch, based on 100 g weight of liquefied sugar with respect to the liquefied sugar;
a fifth step of cooling the mixture to a temperature of 18° C. while the mixture is evenly compressed to a thickness of 3 to 5 mm through a compression member;
a sixth step of cutting the cooled mixture into a plurality of chips while maintaining a planarized state with respect to the cooled mixture; and
a seventh step of heating and cooling the chips of the cut mixture in a state in which the chips of the cut mixture are arranged to have a predetermined interval on the surface of the primarily formed scorched rice base made of brown rice.

4. The method of claim 3, wherein the liquefied sugar further comprises 4 to 9 mg content of calcium, 1 to 2 mg content of magnesium, and 1 to 147 mg content of potassium based on 100 g content of the liquefied sugar.
